(19) United States
(12) Patent Application Publication
(10) Pub. No.: US 2026/0320481 A1
(43) Pub. Date: Oct. 15, 2026

(54) SYSTEMS AND METHODS OF PERSISTENT MEMORY FOR MACHINE LEARNING TRAINING APPLICATIONS

(71) Applicant: Samsung Electronics Co., Ltd., Suwon-si (KR)

(72) Inventor: Oscar P. PINTO, San Jose, CA (US)

(21) Appl. No.: 19/274,271

(22) Filed: Jul. 18, 2025

Related U.S. Application Data
(60) Provisional application No. 63/789,417, filed on Apr. 15, 2025.

(51) Int. Cl. G06N 20/00

(52) U.S. Cl. CPC G06N 20/00

(57) ABSTRACT

Provided are systems, methods, and apparatuses of persistent memory for machine learning training applications. In one or more examples, the systems, devices, and methods include receiving, based on a request, an allocation of persistent memory associated with a processor executing at least a portion of a model training process to train a machine learning model, the allocation being requested based on freezing a state of the model training process; saving a snapshot of the state of the model training process to the allocation of the persistent memory; and transferring, based on unfreezing the state of the model training process, the snapshot from the persistent memory to a storage drive.

### CROSS-REFERENCE TO RELATED APPLICATIONS

This application claims the benefit of U.S. Provisional Patent Application Ser. No. 63/789,417, filed Apr. 15, 2025, which is incorporated by reference herein for all purposes.

### TECHNICAL FIELD

The subject matter disclosed relates to memory systems. In particular, the subject matter relates to systems and methods of persistent memory for machine learning training applications.

### BACKGROUND

The present background section is intended to provide context only, and the disclosure of any concept in this section does not constitute an admission that said concept is prior art.

Compute express link (CXL) memory can include technology that expands memory capacity beyond what is available with some random-access memory (e.g., dynamic random-access memory (DRAM)). CXL can allow for greater memory bandwidth and capacity based on implementing a high-speed, cache-coherent interconnect, allowing processors (e.g., central processor unit (CPU)) to access shared memory on attached devices, enabling pooling and sharing of memory resources. CXL can include a high-speed, low-latency processor-to-device interconnect technology built on the peripheral component interconnect express (PCIe) physical layer.

### SUMMARY

In various embodiments, the systems and methods described herein include systems, methods, and apparatuses of persistent memory for machine learning training applications. In some aspects, a method includes receiving, based on a request, an allocation of persistent memory associated with a processor executing at least a portion of a model training process to train a machine-learning model, the allocation being requested upon freezing a state of the training process; saving a snapshot of that state into the persistent memory; and, upon unfreezing the state, transferring the snapshot from the persistent memory to a storage drive.

The method further includes scheduling the transfer upon unfreezing; requesting and configuring the persistent-memory allocation via a fabric manager operating under a cache-coherent protocol; receiving a second allocation of the storage drive in response to a subsequent request; freeing the persistent-memory allocation once the snapshot is transferred; executing an instruction on the processor concurrently with the transfer; and employing battery-backed or capacitor-backed DRAM as the persistent memory, a solid-state drive as the storage drive, storing data in memory cells and in blocks, and maintaining physical connections between the persistent memory, the storage drive, and the processor, which may include a graphical processing unit (GPU).

In some embodiments, a device includes one or more processors and memory storing instructions that, when executed by the processors, cause the device to perform the above method. In particular, the processors are further configured to schedule the snapshot transfer upon unfreezing, to request and configure allocations through a fabric manager under a cache-coherent protocol, to free the persistent-memory allocation after transfer, and to execute instructions concurrently with the transfer, all while employing DRAM-based persistent memory and an SSD as described.

The processors may also be configured to receive the allocation by requesting a fabric manager to provide the allocation to the persistent memory, with the fabric manager configuring the allocation of the persistent memory and operating based on a cache coherent protocol. The transfer of the snapshot from the persistent memory to the storage drive may be based on receiving a second allocation of the storage drive in response to a second request. The processors may free the allocation of the persistent memory based on a determination that the snapshot is transferred from the persistent memory to the storage drive, and may execute an instruction concurrently with the snapshot being transferred. The persistent memory may include battery-backed or capacitor-backed DRAM, the storage drive may include a solid-state drive, and the processors may include at least one graphical processing unit.

In some embodiments, a non-transitory computer-readable medium stores code that, when executed by one or more processors, directs the processors to carry out the method recited above, including scheduling the transfer upon unfreezing, fabric-manager allocation under a cache-coherent protocol, freeing memory after transfer, concurrent execution, and use of the specified persistent memory and storage drive.

The code may further include instructions executable by the processor to schedule, based on unfreezing the state of the model training process, the transferring of the snapshot from the persistent memory to the storage drive. Receiving the allocation may be based on the processors requesting a fabric manager to provide the allocation, the fabric manager configuring the allocation, and the persistent memory and the fabric manager operating based on a cache coherent protocol.

The systems and methods of persistent memory for machine learning training applications described herein include multiple advantages and benefits. For example, the systems and methods described herein decrease compute idle times during model training checkpoints by switching storage with CXL PMEM. Also, the systems and methods described herein can transfer CXL memory contents to slower storage when compute resumes (e.g., in parallel with model training resuming). Additionally, the systems and methods described herein decrease the time it takes to train machine learning applications.

### BRIEF DESCRIPTION OF THE DRAWINGS

The above-mentioned aspects and other aspects of the present systems and methods will be better understood when the present application is read in view of the following figures in which like numbers indicate similar or identical elements. Further, the drawings provided herein are for purpose of illustrating certain embodiments only; other embodiments, which may not be explicitly illustrated, are not excluded from the scope of this disclosure.

These and other features and advantages of the present disclosure will be appreciated and understood with reference to the specification, claims, and appended drawings, wherein:

FIG. 1 illustrates an example system in accordance with one or more implementations as described herein.

FIG. 2 illustrates details of the system of FIG. 1, according to one or more implementations as described herein.

FIG. 3 illustrates an example system flow in accordance with one or more implementations as described herein.

FIG. 4 depicts a flow diagram illustrating an example method associated with the disclosed systems, in accordance with example implementations described herein.

FIG. 5 depicts a flow diagram illustrating an example method associated with the disclosed systems, in accordance with example implementations described herein.

While the present systems and methods are susceptible to various modifications and alternative forms, specific embodiments thereof are shown by way of example in the drawings and will herein be described. The drawings may not be to scale. It should be understood, however, that the drawings and detailed description thereto are not intended to limit the present systems and methods to the particular form disclosed, but to the contrary, the intention is to cover all modifications, equivalents, and alternatives falling within the spirit and scope of the present systems and methods as defined by the appended claims.

### DETAILED DESCRIPTION OF VARIOUS EMBODIMENTS

The details of one or more embodiments of the subject matter described herein are set forth in the accompanying drawings and the description below. Other features, aspects, and advantages of the subject matter will become apparent from the description, the drawings, and the claims.

Various embodiments of the present disclosure now will be described more fully hereinafter with reference to the accompanying drawings, in which some, but not all embodiments are shown. Indeed, the disclosure may be embodied in many forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout. Arrows in each of the figures depict bi-directional data flow and/or bi-directional data flow capabilities. The terms “path,” “pathway” and “route” are used interchangeably herein.

Embodiments of the present disclosure may be implemented in various ways, including as computer program products that comprise articles of manufacture. A computer program product may include a non-transitory computer-readable storage medium storing applications, programs, program components, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media includes all computer-readable media (including volatile and non-volatile media).

In one embodiment, a non-volatile computer-readable storage medium may include a floppy disk, flexible disk, hard disk, solid-state storage (SSS) (for example a solid-state drive (SSD)), solid state card (SSC), solid state module (SSM), enterprise flash drive, magnetic tape, or any other non-transitory magnetic medium, and/or the like. A non-volatile computer-readable storage medium may include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may include read-only memory (ROM), programmable read-only memory (PROM), erasable programmable read-only memory (EPROM), electrically erasable programmable read-only memory (EEPROM), flash memory (for example Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may include conductive-bridging random-access memory (CBRAM), phase-change random-access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random-access memory (FJG RAM), Millipede memory, racetrack memory, and/or the like.

In one embodiment, a volatile computer-readable storage medium may include random-access memory (RAM), dynamic random-access memory (DRAM), static random-access memory (SRAM), fast page mode dynamic random-access memory (FPM DRAM), extended data-out dynamic random-access memory (EDO DRAM), synchronous dynamic random-access memory (SDRAM), double data rate synchronous dynamic random-access memory (DDR SDRAM), double data rate type two synchronous dynamic random-access memory (DDR2 SDRAM), double data rate type three synchronous dynamic random-access memory (DDR3 SDRAM), Rambus dynamic random-access memory (RDRAM), Twin Transistor RAM (TTRAM), Thyristor RAM (T-RAM), Zero-capacitor (Z-RAM), Rambus in-line memory component (RIMM), dual in-line memory component (DIMM), single in-line memory component (SIMM), video random-access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of a hardware embodiment, a computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, a hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially, such that one instruction is retrieved, loaded, and executed at a time. In some examples, retrieval, loading, and/or execution may be performed in parallel, such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not be necessarily all referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms, and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms, and a plural term may include the corresponding singular form. It is further noted that various figures (including component diagrams) shown and discussed herein are for illustrative purpose only, and are not drawn to scale. Similarly, various waveforms and timing diagrams are shown for illustrative purpose only. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some embodiments and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly referenced parts/modules are the only way to implement some of the embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on chip (SoC), an assembly, and so forth.

The provided description is presented to enable one of ordinary skill in the art to make and use the subject matter disclosed herein and to incorporate it in the context of particular applications. While the following is directed to specific examples, other and further examples may be devised without departing from the basic scope thereof.

Various modifications, as well as a variety of uses in different applications, will be readily apparent to those skilled in the art, and the general principles defined herein may be applied to a wide range of embodiments. Thus, the subject matter disclosed herein is not intended to be limited to the embodiments presented, but is to be accorded the widest scope consistent with the principles and novel features disclosed herein.

In the description provided, numerous specific details are set forth in order to provide a more thorough understanding of the subject matter disclosed herein. It will, however, be apparent to one skilled in the art that the subject matter disclosed herein may be practiced without necessarily being limited to these specific details. In other instances, well-known structures and devices are shown in block diagram form, rather than in detail, in order to avoid obscuring the subject matter disclosed herein.

All the features disclosed in this specification (e.g., any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Various features are described herein with reference to the figures. It should be noted that the figures are only intended to facilitate the description of the features. The various features described are not intended as an exhaustive description of the subject matter disclosed herein or as a limitation on the scope of the subject matter disclosed herein. Additionally, an illustrated example need not have all the aspects or advantages shown. An aspect or an advantage described in conjunction with a particular example is not necessarily limited to that example and can be practiced in any other examples even if not so illustrated, or if not so explicitly described.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the Claims herein is not intended to invoke the provisions of 35 U.S.C. 112, Paragraph 6.

It is noted that, if used, the labels left, right, front, back, top, bottom, forward, reverse, clockwise and counterclockwise have been used for convenience purposes only and are not intended to imply any particular fixed direction. Instead, the labels are used to reflect relative locations and/or directions between various portions of an object.

Data processing may include data buffering, aligning incoming data from multiple communication lanes, forward error correction (FEC), etc. For example, data may be received by an analog front end (AFE), which can prepare the incoming data for digital processing. The digital portion of the transceivers (e.g., digital signal processor (DSP)) may provide skew management, equalization, reflection cancellation, and/or other functions. It is to be appreciated that the process described herein can provide many benefits, including saving both power and cost.

Moreover, the terms “system,” “component,” “module,” “interface,” “model,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless explicitly stated otherwise, each numerical value and range may be interpreted as being approximate, as if the word “about” or “approximately” preceded the value of the value or range. Signals and corresponding nodes or ports might be referred to by the same name and are interchangeable for purposes here.

While embodiments may have been described with respect to circuit functions, the embodiments of the subject matter disclosed herein are not limited. Possible implementations may be embodied in a single integrated circuit, a multi-chip module, a single card, SoC, or a multi-card circuit pack. As would be apparent to one skilled in the art, the various embodiments might also be implemented as part of a larger system. Such embodiments may be employed in conjunction with, for example, a digital signal processor, microcontroller, field-programmable gate array, application-specific integrated circuit, or general-purpose computer.

As would be apparent to one skilled in the art, various functions of circuit elements may also be implemented as processing blocks in a software program. Such software may be employed in, for example, a digital signal processor, microcontroller, or general-purpose computer. Such software may be embodied in the form of program code embodied in tangible media, such as magnetic recording media, optical recording media, solid-state memory, floppy diskettes, CD-ROMs, hard drives, or any other non-transitory machine-readable storage medium, that when the program code is loaded into and executed by a machine, such as a computer, the machine becomes an apparatus for practicing the subject matter disclosed herein. When implemented on a general-purpose processor, the program code segments combine with the processor to provide a unique device that operates analogously to specific logic circuits. Described embodiments may also be manifest in the form of a bit stream or other sequence of signal values electrically or optically transmitted through a medium, stored magnetic-field variations in a magnetic recording medium, etc., generated using a method and/or an apparatus as described herein.

The systems and methods described herein may be based on and/or may include CXL memory. CXL memory may include CXL persistent memory (PMEM), which may refer to the use of CXL as an interconnect for non-volatile memory (e.g., battery-backed DRAM, capacitor-backed DRAM), allowing data to persist when power is lost or removed. The systems and methods described herein configures one or more CXL PMEM memory devices for checkpointing in training path of artificial intelligence/machine learning (AI/ML) applications. Such training processes may be relatively lengthy and time consuming and include relatively large data set sizes. Training can take several hours or even months, depending on the use-case model employed and the accuracy requirements chosen. Performance of training is improved by scaling to multiple GPUs/accelerators and distribution of load on multiple machines. While distributed training can reduce the overall training time, some architectures are still susceptible to unrecoverable hardware and software failures that can consume days to months of training time.

The state of the model may be saved using checkpointing periodically for fault tolerance in the event of a failure. The recovery process can ensure that application behavior and continuity are maintained. Without checkpointing, the progress of an in-process training run may be lost based on a system failure (e.g., hardware failure, GPU failure, application error, etc.), and the training run may have to be restarted from the beginning of the run.

With distributed training, each node can account for its own additional checkpoint data, which may cross into the gigabyte range. This data cannot be relatively large since each checkpoint stage adds serialization and adding relatively large checkpoint data may slowdown the training cycle.

The collective data also may be persistent and saved to relatively fast storage media, such as SSDs, where compression may be employed to save on bandwidth and network utilization. Some SSDs may provide a write bandwidth of 2GB/s, which can degrade as more checkpoints are populated simultaneously to the same persistent media. GPUs may be stalled during checkpointing, which results in wasted cycles and adds to usage costs in the datacenter.

Checkpointing has relatively high bandwidth and storage constraints, which only continue to get larger with each new and larger model. In some cases, storage is not able to keep pace due to which AI resources not being properly utilized. The systems and methods may include a CXL-based PMEM solution. A CXL-based PMEM solution has the latency and bandwidth characteristics of local DRAM with the added persistence, which makes such a device both unique and desirable. The CXL-based PMEM solution helps mitigate the cost of checkpointing in current and future training applications.

Some systems may use machine learning (ML) models, which can be based on graphical processing units (GPUs). ML models continue to grow in size (e.g., doubling every 3.4 months). Based on the growing size of ML models, ML training processes continue to grow as well, increasing the time it takes to train ML models. Training ML models can take several hours or even several months, depending on the use-case models employed, accuracy constraints, etc. In some cases, complex distributed compute environments can perform training and inference tasks. Distributed training can reduce training time from weeks to days or hours with certain models.

Some systems may be susceptible to unrecoverable hardware and/or software failures (e.g., due to the time-consuming nature of large-scale training and the use of multiple resources). Such failures can result in setbacks and delay that can take hours, days, weeks, or even months away from training time. Such failures can be relatively common (e.g., ~30% faulty GPUs during large language model training runs).

With some systems, saving a state of the model periodically can be helpful (e.g., based on delays and setbacks), providing a level of fault tolerance in the event of failure. Accordingly, checkpointing may be periodically employed to save model state, and may be employed for transfer learning, gradient checkpointing, etc.

In some systems, checkpointing can introduce idle times in compute. Checkpointing can be serialized. Based on checkpointing with some systems, relatively expensive compute can be left idle for multiple cycles in a data center. Checkpointing can be performance and/or bandwidth limited.

Some systems employ snapshots for checkpoint logic and stores them to storage media from time to time. Some systems may implement Checkpoint logic that uses CXL PMEM in main path and defers CXL contents to storage once compute resumes.

The systems and methods described herein provide an integrated CXL-GPU and CXL-memory that use CXL-MEM modules for reference and checkpoint and are implementation specific. The systems and methods described herein temporarily commits to PMEM with the option to transfer to slower storage in parallel when training resumes.

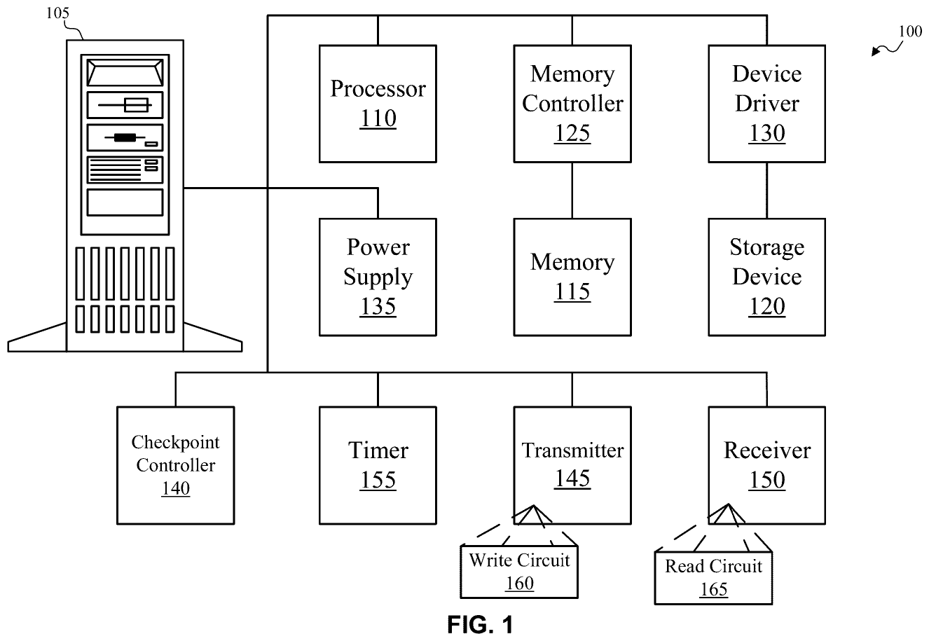

FIG. 1 illustrates an example system 100 in accordance with one or more implementations as described herein. In FIG. 1, machine 105, which may be termed a host, a system, or a server, is shown. While FIG. 1 depicts machine 105 as a tower computer, embodiments of the disclosure may extend to any form factor or type of machine. For example, machine 105 may be a rack server, a blade server, a desktop computer, a tower computer, a mini tower computer, a desktop server, a laptop computer, a notebook computer, a tablet computer, etc.

Machine 105 may include processor 110, memory 115, and storage device 120. Processor 110 may be any variety of processor. It is noted that processor 110, along with the other components discussed below, are shown outside the machine for ease of illustration: embodiments of the disclosure may include these components within the machine. While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 may be any variety of memory, such as flash memory, DRAM, SRAM, Persistent Random-access memory, Ferroelectric Random-access memory (FRAM), or Non-Volatile Random-access memory (NVRAM), such as Magnetoresistive Random-access memory (MRAM), Phase Change Memory (PCM), or Resistive Random-Access Memory (ReRAM). Memory 115 may include volatile and/or non-volatile memory. Memory 115 may use any desired form factor: for example, Single In-Line Memory Module (SIMM), Dual In-Line Memory Module (DIMM), Non-Volatile DIMM (NVDIMM), etc. Memory 115 may be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may support an operating system under which various applications may be running. These applications may issue requests (which may be termed commands) to read data from or write data to either memory 115 or storage device 120. When storage device 120 is used to support applications reading or writing data via some sort of file system, storage device 120 may be accessed using device driver 130. While FIG. 1 shows one storage device 120, there may be any number (one or more) of storage devices in machine 105. Storage device 120 may support any desired protocol or protocols, including, for example, the Non-Volatile Memory Express (NVMe®) protocol, a Serial Attached Small Computer System Interface (SCSI) (SAS) protocol, or a Serial AT Attachment (SATA) protocol. Storage device 120 may include any desired interface, including, for example, a Peripheral Component Interconnect Express (PCIe®) interface, or a Compute Express Link (CXL®) interface. Storage device 120 may take any desired form factor, including, for example, a U.2 form factor, a U.3 form factor, a M.2 form factor, Enterprise and Data Center Standard Form Factor (EDSFF) (including all of its varieties, such as E1 short, E1 long, and the E3 varieties), or an Add-In Card (AIC).

While FIG. 1 uses the term “storage device,” embodiments of the disclosure may include any storage device formats that may benefit from the use of computational storage units, examples of which may include hard disk drives, Solid State Drives (SSDs), or persistent memory devices, such as PCM, ReRAM, or MRAM. Any reference to “storage device” “SSD” below should be understood to include such other embodiments of the disclosure and other varieties of storage devices. In some cases, the term “storage unit” may encompass storage device 120 and memory 115. Machine 105 may include power supply 135. Power supply 135 may provide power to machine 105 and its components.

Machine 105 may include transmitter 145 and receiver 150. Transmitter 145 or receiver 150 may be respectively used to transmit or receive data. In some cases, transmitter 145 and/or receiver 150 may be used to communicate with memory 115 and/or storage device 120. Transmitter 145 may include write circuit 160, which may be used to write data into storage, such as a register, in memory 115 and/or storage device 120. In a similar manner, receiver 150 may include read circuit 165, which may be used to read data from storage, such as a register, from memory 115 and/or storage device 120.

In the illustrated example, machine 105 may include timer 155, which may be used to time one or more operations, indicate or measure a time period, indicate a lapse of time, indicate an expiration, indicate a timeout, etc.

In one or more examples, machine 105 may be implemented with any type of apparatus. Machine 105 may be configured as (e.g., as a host of) one or more servers, such as a compute server, a storage server, storage node, a network server, a supercomputer, data center system, and/or the like, or any combination thereof. Additionally, or alternatively, machine 105 may be configured as (e.g., as a host of) one or more computers, such as a workstation, a personal computer, a tablet, a smartphone, and/or the like, or any combination thereof. Machine 105 may be implemented with any type of apparatus that may be configured as a device including, for example, an accelerator device, a storage device, a network device, a memory expansion and/or buffer device, a central processing unit (CPU), a graphics processing unit (GPU), a neural processing unit (NPU), a tensor processing unit (TPU), optical processing units (OPU), and/or the like, or any combination thereof.

Any communication between devices including machine 105 (e.g., host, computational storage device, and/or any intermediary device) can occur over an interface that may be implemented with any type of wired and/or wireless communication medium, interface, protocol, and/or the like including PCIe, NVMe, Ethernet, NVMe-oF, Compute Express Link (CXL), and/or a coherent protocol such as CXL. mem, CXL. cache, CXL. IO and/or the like, Gen-Z, Open Coherent Accelerator Processor Interface (OpenCAPI), Cache Coherent Interconnect for Accelerators (CCIX), Advanced eXtensible Interface (AXI) and/or the like, or any combination thereof, Transmission Control Protocol/Internet Protocol (TCP/IP), FibreChannel, InfiniBand, Serial AT Attachment (SATA), Small Computer Systems Interface (SCSI), Serial Attached SCSI (SAS), iWARP, any generation of wireless network including 2G, 3G, 4G, 5G, and/or the like, any generation of Wi-Fi, Bluetooth, near-field communication (NFC), and/or the like, or any combination thereof. In some embodiments, the communication interfaces may include a communication fabric including one or more links, buses, switches, hubs, nodes, routers, translators, repeaters, and/or the like. In some embodiments, system 100 may include one or more additional apparatus having one or more additional communication interfaces.

As shown, machine 105 may include replication controller 140. In some examples, checkpoint controller 140 may include logic (e.g., logic circuit, electrical circuit), hardware (e.g., processing unit, memory, storage), software, firmware, and the like. In some cases, checkpoint controller 140 may perform one or more functions in conjunction with processor 110. In some cases, at least a portion of checkpoint controller 140 may be implemented in or by processor 110 and/or memory 115. The one or more logic circuits of checkpoint controller 140 may include any one or combination of multiplexers, registers, logic gates, arithmetic logic units (ALUs), cache, computer memory, microprocessors, processing units (CPUs, GPUs, NPUs, and/or TPUs), FPGAs, ASICs, etc., that enable checkpoint controller 140 to provide systems and methods of persistent memory for machine learning training applications.

Any of the functionality described herein, including any of the host functionality, device functionally, checkpoint controller 140 functionality, and/or the like, may be implemented with hardware, software, firmware, or any combination thereof including, for example, hardware and/or software combinational logic, sequential logic, timers, counters, registers, state machines, volatile memories such as at least one of or any combination of the following: DRAM and/or SRAM, nonvolatile memory including flash memory, persistent memory such as cross-gridded nonvolatile memory, memory with bulk resistance change, PCM, and/or the like and/or any combination thereof, complex programmable logic devices (CPLDs), field programmable gate arrays (FPGAs), application specific integrated circuits (ASICs), CPUs including CISC processors such as x86 processors and/or RISC processors such as RISC-V and/or advanced RISC machine (ARM) processors, GPUs, NPUs, TPUs, OPUs, and/or the like, executing instructions stored in any type of memory. In some embodiments, one or more components of checkpoint controller 140 may be implemented as an SoC.

In one or more examples, checkpoint controller 140 may decrease compute idle times during model training checkpoints by switching storage with CXL PMEM. Also, checkpoint controller 140 can transfer CXL memory contents (e.g., checkpoint data) to slower storage when compute resumes (e.g., transfer in parallel with model training resuming). Additionally, the systems and methods described herein decrease the time it takes to train machine learning applications.

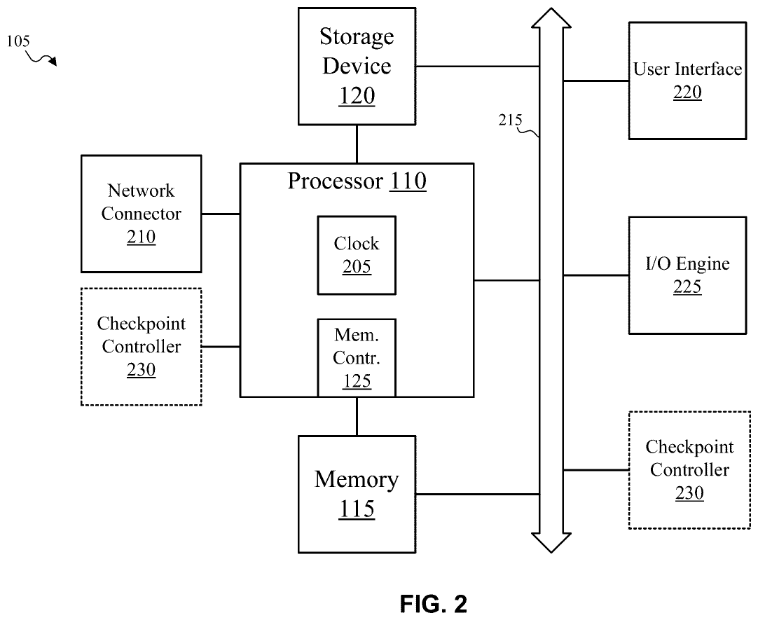

FIG. 2 illustrates details of machine 105 of FIG. 1, according to examples described herein. In the illustrated example, machine 105 may include processor 110. Processor 110 may include one or more processors and/or one or more dies. Processor 110 may include memory controller 125 (e.g., one or more memory controllers) and clock 205 (e.g. one or more clocks), which may be used to coordinate the operations of the components of the machine. Processor 110 may be coupled to memory 115 (e.g., one or more memory chips, stacked memory, etc.), which may include random-access memory (RAM), read-only memory (ROM), or other state preserving media, as examples. Processor 110 may be coupled to storage device 120 (e.g., one or more storage devices), and to network connector 210, which may be, for example, an Ethernet connector or a wireless connector. Processor 110 may be connected to bus 215 (e.g., one or more buses), to which may be attached user interface 220 (e.g., one or more user interfaces) and Input/Output (I/O) interface ports that may be managed using I/O engine 225 (e.g., one or more I/O engines), among other components. As shown, processor 110 may be coupled to checkpoint controller 230, which may be an example of checkpoint controller 140 of FIG. 1. Additionally, or alternatively, processor 110 may be connected to bus 215, to which may be attached checkpoint controller 230.

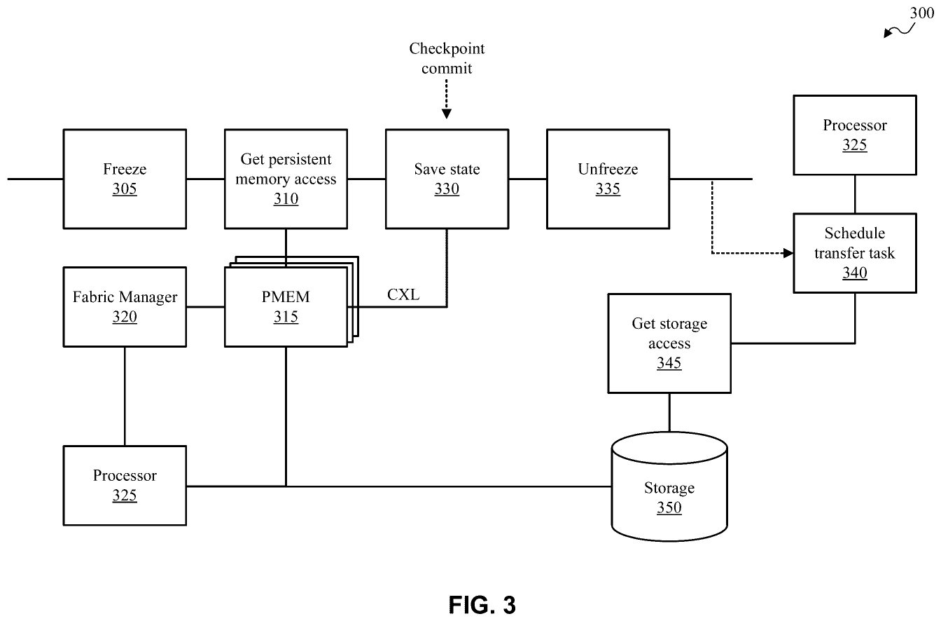

FIG. 3 illustrates an example system flow 300 in accordance with one or more implementations as described herein. In some configurations, one or more aspects and/or one or more components of system flow 300 may be implemented by or in conjunction with checkpoint controller 140 of FIG. 1 and/or checkpoint controller 230 of FIG. 2. In some configurations, one or more aspects of system flow 300 may be implemented by or in conjunction with machine 105, components of machine 105, or any combination thereof.

In some examples, one or more processors (e.g., processor 325) of a system (e.g., system 100, a system of system flow 300) may execute a model training process to train a machine learning model. In some cases, the one or more processors may include at least one GPU executing at least a portion of the model training process.

At 305, processor 325 may freeze a state of the model training process. The freezing of the state of the model training process may freeze values in memory, freeze values in registers, prevent parts of the model from updating parameters (e.g., weights, biases), etc.

At 310, processor 325 may request to access at least one persistent memory (PMEM) of one or more PMEM devices (e.g., PMEM 315). In some cases, PMEM 315 may represent an available pool of CXL memory, and fabric manager 320 may allocate memory from the available pool of CXL memory.

Fabric manager 320 may be configured as a CXL fabric manager. A CXL fabric manager (FM) can include application-specific logic responsible for composing and managing CXL fabrics, which can include networks of processors, memory, and other devices interconnected via CXL, ensuring the overall stability and functionality of the CXL fabric. A CXL fabric manager may be referred to as the operational control center of a CXL system, handling tasks such as resource allocation, memory pooling, device discovery, initialization, inter-switch link management, fabric configuration, etc.

In some cases, processor 325 may request the access in conjunction with fabric manager 320. Fabric manager 320 (e.g., in conjunction with processor 325) may control one or more aspects of PMEM 315. Fabric manager 320 may control access to PMEM 315, configure PMEM 315, configure allocations of the memory resources of PMEM 315, etc. In some cases, based on a request from processor 325, fabric manager 320 may configure an allocation for the model training process. Accordingly, processor 325 may receive, based on the request, an allocation of PMEM 315, where the allocation may be requested based on freezing a state of the model training process.

In some examples, at least a portion of the allocation a may be an on-demand allocation created dynamically (e.g., from an available pool of CXL memory), where memory resources are allocated during program execution in response to the request. Additionally, or alternatively, at least a portion of the allocation may be pre-allocated or based on a fixed amount of memory determined before being requested.

At 330, processor 325 may save a state of the model training process to the provided allocation of PMEM 315. In some cases, processor 325 may save a snapshot of the state of the model training process to the allocation of PMEM 315. For a given moment in time (e.g., at the moment the freeze occurs), processor 325 may create a point-in-time copy or snapshot of memory and activity associated with the model training process. Processor 325 may capture, at the time of the freezing, information currently being processed by the model training process, stored by the model training process, etc. Processor 325 may store the captured information in the allocation of PMEM 315.

In some cases, PMEM 315 may operate based on a cache coherent protocol (e.g., CXL), which may enable processor 325 to write the captured information to PMEM 315 faster than it would take to store the captured information to a storage drive (e.g., storage 350). In some cases, the captured information may be written to PMEM 315 at a transfer rate anywhere from 64 gigabytes per second (GBps) to 256 GBps (e.g., at up to memory write speeds that are equivalent to memory read speeds). Accordingly, the processor 325 transferring the captured information to PMEM 315 has a relatively small impact (e.g., relatively small delay) to the model training process.

As shown in the example of system flow 300, a given system may include one or more PMEM devices (e.g., at least PMEM 315). In some cases, adding multiple PMEM devices to a host can increase data transfer rates. The one or more PMEM devices may be incorporated directly (e.g., directly attached to the host) and/or through a switch (e.g., via a disaggregated switch). With PMEM devices, the write performance can scale based on the number of ports and respective link widths. For example, with 4×PCIe Gen 7×16 link width PMEM devices, the write transfer rate can scale up to 1 terabyte per second (TBps).

At 335, processor 325 may unfreeze the model training process. In some cases, processor 325 may unfreeze the model training process based on processor 325 determining that the snapshot has been transferred to PMEM 315. Based on the unfreezing, the one or more processors (e.g., including processor 325) may resume executing the model training process to train the machine learning model.

At 340, processor 325 may schedule, based on the unfreezing of the model training process, a transfer of the snapshot from PMEM 315 to storage 350.

At 345, processor 325 may request to access at least one storage device of one or more storage devices (e.g., storage 350). In some cases, storage 350 may storage media (e.g., non-volatile storage media) for storage of data (e.g., one or more snapshots).

In some cases, processor 325 may transfer (e.g., based on the scheduling and/or being granted access to storage 350) the snapshot from PMEM 315 to storage 350. In some cases, processor 325 may transfer the snapshot from PMEM 315 to storage 350 based on the unfreezing (e.g., with or without the scheduling). In some cases, transferring the snapshot from PMEM 315 to storage 350 may be based on processor 325 receiving an allocation of storage 350 (e.g., based processor 325 requesting the allocation of storage 350).

In some cases, processor 325 may transfer the snapshot from PMEM 315 to storage 350 concurrently with the one or more processors resuming execution of the model training process. Thus, the transfer of the snapshot to storage 350 may overlap with execution of the model training process. Accordingly, the transfer of the snapshot to storage 350 may reduce or avoid delays to execution of the model training process. In some implementations, processor 325 may free the allocation of PMEM 315 based on processor 325 determining that the snapshot is transferred from PMEM 315 to the storage 350.

In some examples, PMEM 315 may include a battery-backed DRAM and/or a capacitor-backed DRAM. In some cases, storage 350 may include a solid-state drive. Processor 325 may include a GPU, a CPU, a microcontroller, a memory controller, etc. In some cases, data in PMEM 315 may be stored in memory cells (e.g., DRAM memory cells) and data in storage 350 may be stored in blocks (e.g., erasable blocks of NAND flash memory). In some cases, PMEM 315, processor 325, and/or storage 350 may be enclosed in a device (e.g., in a single enclosure, in a rack-mountable device, etc.).

In some cases, system flow 300 may provide a checkpoint process with relatively low latency and cache coherency. In some cases, system flow 300 may reduce GPU idle times associated with performing checkpoints on model training processes. PMEM 315 may be based on disaggregated CXL memory that is scalable by design. The operations of system flow 300 may be associated with at least one node of a model training system. PMEM 315 may be based on a dynamic memory pool that is shareable with nodes of other systems. System flow 300 may provide a slower storage path (e.g., to storage 350) once a checkpoint is completed, allowing the checkpoint data to be transferred to block storage in parallel with execution of the model training process.

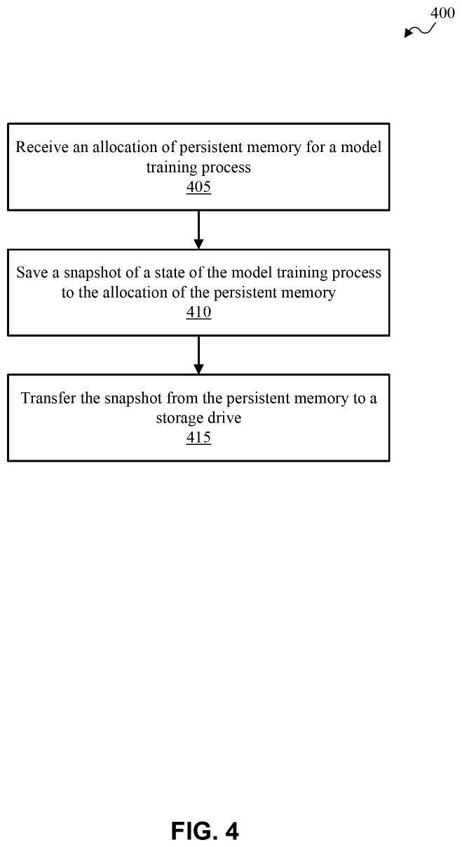

FIG. 4 depicts a flow diagram illustrating an example method 400 associated with the disclosed systems, in accordance with example implementations described herein. In some configurations, one or more aspects of method 400 may be implemented by or in conjunction with checkpoint controller 140 of FIG. 1 and/or checkpoint controller 230 of FIG. 2. In some configurations, one or more aspects of method 400 may be implemented by or in conjunction with machine 105, components of machine 105, or any combination thereof. The depicted method 400 is just one implementation and one or more operations of method 400 may be rearranged, reordered, omitted, and/or otherwise modified such that other implementations are possible and contemplated.

At 405, method 400 may include receiving an allocation of persistent memory for a model training process. For example, checkpoint controller 140 may receive an allocation of persistent memory. The persistent memory may be associated with a processor executing at least a portion of a model training process to train a machine learning model. A fabric manager may configure the allocation based on checkpoint controller 140 requesting the allocation from the fabric manager. The fabric manager may be configured to manage the persistent memory. In some cases, the allocation may be requested based on checkpoint controller 140 freezing a state of the model training process.

At 410, method 400 may include saving a snapshot of a state of the model training process to the allocation of the persistent memory. For example, checkpoint controller 140 may save a snapshot of the state of the model training process to the allocation of the persistent memory.

At 415, method 400 may include transferring the snapshot from the persistent memory to a storage drive. For example, checkpoint controller 140 may transfer the snapshot from the persistent memory to a storage drive. In some cases, checkpoint controller 140 may transfer the snapshot based on checkpoint controller 140 unfreezing the state of the model training process.

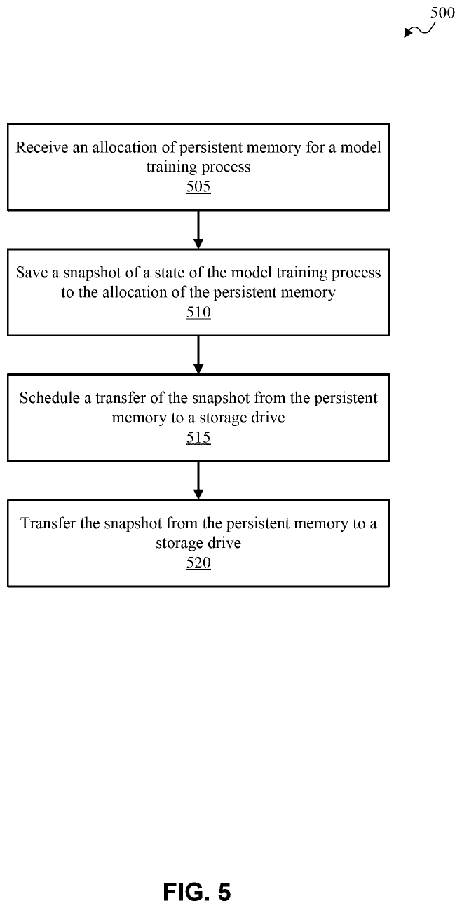

FIG. 5 depicts a flow diagram illustrating an example method 500 associated with the disclosed systems, in accordance with example implementations described herein. In some configurations, one or more aspects of method 500 may be implemented by or in conjunction with checkpoint controller 140 of FIG. 1 and/or checkpoint controller 230 of FIG. 2. In some configurations, one or more aspects of method 500 may be implemented by or in conjunction with machine 105, components of machine 105, or any combination thereof. The depicted method 500 is just one implementation and one or more operations of method 500 may be rearranged, reordered, omitted, and/or otherwise modified such that other implementations are possible and contemplated.

At 505, method 500 may include receiving an allocation of persistent memory for a model training process. For example, checkpoint controller 140 may receive an allocation of persistent memory. The persistent memory may be associated with a processor executing at least a portion of a model training process to train a machine learning model. A fabric manager may configure the allocation based on checkpoint controller 140 requesting the allocation from the fabric manager. The fabric manager may be configured to manage the persistent memory. In some cases, the allocation may be requested based on checkpoint controller 140 freezing a state of the model training process.

At 510, method 500 may include saving a snapshot of a state of the model training process to the allocation of the persistent memory. For example, checkpoint controller 140 may save a snapshot of the state of the model training process to the allocation of the persistent memory.

At 515, method 500 may include scheduling a transfer of the snapshot from the persistent memory to a storage drive. For example, checkpoint controller 140 may schedule the transfer of the snapshot from the persistent memory to a storage drive. In some cases, checkpoint controller 140 may schedule the transfer of the snapshot based on checkpoint controller 140 unfreezing the state of the model training process.

At 520, method 500 may include transferring the snapshot from the persistent memory to a storage drive. For example, checkpoint controller 140 may transfer the snapshot from the persistent memory to a storage drive. In some cases, checkpoint controller 140 may transfer the snapshot based on checkpoint controller 140 scheduling the transfer of the snapshot from the persistent memory to the storage drive.

In the examples described herein, the configurations and operations are example configurations and operations, and may involve various additional configurations and operations not explicitly illustrated. In some examples, one or more aspects of the illustrated configurations and/or operations may be omitted. In some embodiments, one or more of the operations may be performed by components other than those illustrated herein. Additionally, or alternatively, the sequential and/or temporal order of the operations may be varied.

Certain embodiments may be implemented in one or a combination of hardware, firmware, and software. Other embodiments may be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wired and/or wireless communication device such as a switch, router, network interface controller, cellular telephone, smartphone, tablet, netbook, wireless terminal, laptop computer, a femtocell, High Data Rate (HDR) subscriber station, access point, printer, point of sale device, access terminal, or other personal communication system (PCS) device. The device may be wireless, wired, mobile, and/or stationary.

As used within this document, the term “communicate” is intended to include transmitting, or receiving, or both transmitting and receiving. Similarly, the bidirectional exchange of data between two devices (both devices transmit and receive during the exchange) may be described as ‘communicating’, when only the functionality of one of those devices is being claimed. The term “communicating” as used herein with respect to wired and/or wireless communication signals includes transmitting the wired and/or wireless communication signals and/or receiving the wired and/or wireless communication signals. For example, a communication unit, which is capable of communicating wired and/or wireless communication signals, may include a wired/wireless transmitter to transmit communication signals to at least one other communication unit, and/or a wired/wireless communication receiver to receive the communication signal from at least one other communication unit.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems following one or more wireless communication protocols, for example, Radio Frequency (RF), Infrared (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth™, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems, and/or networks.

Although an example processing system has been described above, embodiments of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more components of computer program instructions, encoded on computer storage medium for execution by, or to control the operation of, information/data processing apparatus. Alternatively, or in addition, the program instructions can be encoded on an artificially-generated propagated signal, for example, a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (for example multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA or an ASIC. The apparatus can also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a component, component, subroutine, object, or other unit suitable for use in a computing environment. A computer program may, but need not, correspond to a file in a file system. A program can be stored in a portion of a file that holds other programs or information/data (for example one or more scripts stored in a markup language document), in a single file dedicated to the program in question, or in multiple coordinated files (for example files that store one or more components, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, for example magnetic, magneto-optical disks, or optical disks. However, a computer need not have such devices. Devices suitable for storing computer program instructions and information/data include all forms of non-volatile memory, media and memory devices, including by way of example semiconductor memory devices, for example EPROM, EEPROM, and flash memory devices; magnetic disks, for example internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, for example, a CRT (cathode ray tube) or LCD (liquid crystal display) monitor, for displaying information/data to the user and a keyboard and a pointing device, for example, a mouse or a trackball, by which the user can provide input to the computer. Other kinds of devices can be used to provide for interaction with a user as well; for example, feedback provided to the user can be any form of sensory feedback, for example visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, for example, as an information/data server, or that includes a middleware component, for example, an application server, or that includes a front-end component, for example, a client computer having a graphical user interface or a web browser through which a user can interact with an embodiment of the subject matter described herein, or any combination of one or more such back-end, middleware, or front-end components. The components of the system can be interconnected by any form or medium of digital information/data communication, for example, a communication network. Examples of communication networks include a local area network (“LAN”) and a wide area network (“WAN”), an inter-network (for example the Internet), and peer-to-peer networks (for example ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (for example, an HTML page) to a client device (for example, for purposes of displaying information/data to and receiving user input from a user interacting with the client device). Information/data generated at the client device (for example, a result of the user interaction) can be received from the client device at the server.

While this specification contains many specific embodiment details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Many modifications and other examples as set forth herein will come to mind to one skilled in the art to which these embodiments pertain to having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method comprising:
receiving, based on a request, an allocation of persistent memory associated with a processor executing at least a portion of a model training process to train a machine learning model, the allocation being requested based on freezing a state of the model training process;
saving a snapshot of the state of the model training process to the allocation of the persistent memory; and
transferring, based on unfreezing the state of the model training process, the snapshot from the persistent memory to a storage drive.

2. The method of claim 1, further comprising scheduling, based on unfreezing the state of the model training process, the transferring of the snapshot from the persistent memory to the storage drive.

3. The method of claim 1, wherein receiving the allocation is based on:
requesting a fabric manager to provide the allocation,
the fabric manager configuring the allocation, and
the persistent memory and the fabric manager operating based on a cache coherent protocol.

4. The method of claim 1, wherein transferring the snapshot from the persistent memory to the storage drive is based on receiving a second allocation of the storage drive in response to a second request.

5. The method of claim 1, further comprising freeing the allocation of the persistent memory based on a determination that the snapshot is transferred from the persistent memory to the storage drive.

6. The method of claim 1, wherein the processor executes an instruction concurrently with the snapshot being transferred from the persistent memory to the storage drive.

7. The method of claim 1, wherein:
the persistent memory comprises at least one of battery-backed dynamic random-access memory (DRAM) or capacitor-backed DRAM,
the storage drive comprises a solid-state drive, and
the processor comprises a graphical processing unit.

8. The method of claim 1, wherein:
data in the persistent memory is stored in memory cells of the persistent memory, and
data in the storage drive is stored in blocks.

9. The method of claim 1, wherein the persistent memory is physically connected to the processor executing the model training process.

10. The method of claim 1, wherein the storage drive is physically connected to the processor executing the ML model training process.

11. A device comprising:
one or more processors; and
memory storing instructions that, when executed by the one or more processors, cause the device to:
receive, based on a request, an allocation of persistent memory associated with the one or more processors executing at least a portion of a model training process to train a machine learning model, the allocation being requested based on freezing a state of the model training process;
save a snapshot of the state of the model training process to the allocation of the persistent memory; and
transfer, based on unfreezing the state of the model training process, the snapshot from the persistent memory to a storage drive.

12. The device of claim 11, wherein the one or more processors are further configured to schedule, based on unfreezing the state of the model training process, the transferring of the snapshot from the persistent memory to the storage drive.

13. The device of claim 11, wherein receiving the allocation is based on:
requesting a fabric manager to provide the allocation to the persistent memory,
the fabric manager configuring the allocation of the persistent memory, and
the persistent memory and the fabric manager operating based on a cache coherent protocol.

14. The device of claim 11, wherein transferring the snapshot from the persistent memory to the storage drive is based on receiving a second allocation of the storage drive in response to a second request.

15. The device of claim 11, wherein the one or more processors are further configured to free the allocation of the persistent memory based on a determination that the snapshot is transferred from the persistent memory to the storage drive.

16. The device of claim 11, wherein the one or more processors execute an instruction concurrently with the snapshot being transferred from the persistent memory to the storage drive.

17. The device of claim 11, wherein:
the persistent memory comprises at least one of battery-backed dynamic random-access memory (DRAM) or capacitor-backed DRAM,
the storage drive comprises a solid-state drive, and
the one or more processors comprises at least one graphical processing unit.

18. A non-transitory computer-readable medium storing code that comprises instructions executable by one or more processors to:
receive, based on a request, an allocation of persistent memory associated with the one or more processors executing at least a portion of a model training process to train a machine learning model, the allocation being requested based on freezing a state of the model training process;
save a snapshot of the state of the model training process to the allocation of the persistent memory; and
transfer, based on unfreezing the state of the model training process, the snapshot from the persistent memory to a storage drive.

19. The non-transitory computer-readable medium of claim 18, wherein the code includes further instructions executable by the processor to schedule, based on unfreezing the state of the model training process, the transferring of the snapshot from the persistent memory to the storage drive.

20. The non-transitory computer-readable medium of claim 18, wherein receiving the allocation is based on:
the one or more processors requesting a fabric manager to provide the allocation,
the fabric manager configuring the allocation, and
the persistent memory and the fabric manager operating based on a cache coherent protocol.
